(19) United States
(12) Patent Application Publication
(10) Pub. No.: US 2005/0104731 A1
(43) Pub. Date: May 19, 2005

(54) System and method for detecting eavesdropping device

(75) Inventor: Yong Hai Park, Seoul (KR)

Correspondence Address: DARBY & DARBY P.C., P. O. BOX 5257, NEW YORK, NY, 10150-5257, US

(73) Assignee: Woojoo IT Co., Ltd., Seoul (KR)

(21) Appl. No.: 10/785,643

(22) Filed: Feb. 23, 2004

(30) Foreign Application Priority Data
Nov. 17, 2003 (KR) 10-2003-80910

(51) Int. Cl. G08B 13/14

(52) U.S. Cl. 340/572.1; 340/552; 342/46; 455/115.1; 340/572.2

(57) ABSTRACT

Disclosed are an eavesdropping device detecting system and a detecting method thereof. The eavesdropping device detects the eavesdropping device based on waves generated from the eavesdropping device and displays a detecting result as a visual image, so an existence of the eavesdropping device as well as a position of the eavesdropping device can be precisely notified to the user. The eavesdropping device detecting system has a wave receiver for receiving predetermined waves, an image alarm outputting section for outputting an existence of an eavesdropping device as at least one of a message and an visual image, and a data processing section for comparing waves received in the wave receiver with waves of the eavesdropping device to judge the existence of the eavesdropping device and outputting a result thereof to the image alarm outputting section.

### BACKGROUND OF THE INVENTION

1. Field of the invention

The present invention relates to a system and a method for detecting a hidden camera or an eavesdropping device, and more particularly to a system and a method for detecting a hidden camera or an eavesdropping device capable of notifying a user of an existence of the hidden camera or the eavesdropping device by displaying a detecting result as a visual image, through detecting such a hidden camera or the eavesdropping device based on waves generated from the hidden camera or the eavesdropping device.

2. Description of the Prior Art

Recently, as electronic civilization makes great strides, various appliances have been automated so that the modern human life has become more prosperous and convenient. However, as an expense for the convenience, a person's private life may be seriously revealed to the public.

That is, as eavesdropping devices, such as a voice recorder, a wiretapping device, and a hidden camera, are being developed and widely spread, persons can conveniently use the eavesdropping devices in required places with an original purpose of such eavesdropping devices. However, it also frequently occurs that such eavesdropping devices are maliciously used with a criminal purpose. A secret or information of a private person, an enterprise or a state may be easily revealed due to abuse of the eavesdropping devices, thereby causing a social problem.

Recently, information or data are easily propagated through mass media such as an Internet. Accordingly, if a private life of an individual or a public person is immorally spread through the mass media by recording one's private life using the eavesdropping devices, reputation of the individual or the public person may be significantly damaged. In fact, we may often find many public persons, who suffer from films photographed with hidden camera, regardless of intention, in newspapers and T.V.

For this reason, a state or an enterprise may periodically check for the existence of eavesdropping devices in important facilities or international conference rooms, so as to prevent important secret from being revealed to the public or to an enemy. In addition, it is required for an individual to periodically check for the existence of eavesdropping devices in private places, in order to prevent private information of the individual from being revealed to the public.

A wave detector for checking the existence of the eavesdropping devices has been designed to be adaptable for large enterprises or national organizations. However, a private person or a small and medium enterprise usually cannot afford to check for the existence of eavesdropping devices by using such a wave detector.

A conventional detecting device for eavesdropping devices generates a buzzing sound when it detects a predetermined wave signal. Accordingly, if an error occurs in the conventional detecting device, the conventional detecting device may operate corresponding to all kinds of waves existing around the detecting device, so it is impossible to precisely judge the existence of eavesdropping devices.

In addition, when an eavesdropping device, such as a hidden camera, is secretly installed, the conventional detecting device cannot precisely detect the position of such an eavesdropping device, so the conventional detecting device is inevitably useless in detecting an eavesdropping device.

Recently available detecting device for hidden cameras has a simple function, in which the detecting device detects intensity of waves existing in a peripheral area thereof and compares the intensity of waves with a reference value. If the intensity of waves exceeds the reference value, the detecting device generates a buzzing sound in order to notify a user of an existence of the hidden camera. That is, the current available detecting device judges the existence of a hidden camera based on the intensity of waves.

Accordingly, the recently available detecting device may generate the buzzing sound even if it detects waves generated from cellular phones or other appliances, so the detecting device has inferior reliability as an eavesdropping device detecting system.

For this reason, the applicant of the present invention suggests an eavesdropping device detecting system capable of detecting an eavesdropping device based on waves generated from the eavesdropping device. According to the eavesdropping device detecting system of the present invention, a detecting result is displayed as a visual image instead of the buzzer sound, so the existence of the eavesdropping device as well as a position of the eavesdropping device can be precisely notified to the user.

### SUMMARY OF THE INVENTION

Accordingly, the present invention has been made to solve the above-mentioned problems occurring in the prior art, and a first object of the present invention is to provide an eavesdropping device detecting system capable of detecting an eavesdropping device based on waves generated from the eavesdropping device and displaying a detecting result as a visual image, so an existence of the eavesdropping device as well as a position of the eavesdropping device can be precisely notified to the user.

A second object of the present invention is to provide an eavesdropping device detecting system fabricated in a simple structure with a compact size and a low cost so as to allow an individual and a small-medium enterpriser to easily use the eavesdropping device detecting system, and a detecting method thereof.

In order to accomplish the first object, there is provided an eavesdropping device detecting system comprising: a wave receiver for receiving predetermined waves; an image alarm outputting section for outputting an existence of an eavesdropping device as at least one of a message and a visual image; and a data processing section for comparing waves received in the wave receiver with waves of the eavesdropping device to judge the existence of the eavesdropping device and outputting a result thereof to the image alarm outputting section.

In order to accomplish the second object, there is provided a method for detecting an eavesdropping device in an eavesdropping device detecting system, the method comprising the steps of: receiving predetermined waves; comparing received waves with waves of the eavesdropping device and judging an existence of the eavesdropping device; and displaying the existence of the eavesdropping device as at least one of a message and a visual image.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block view showing an eavesdropping device detecting system according to one embodiment of the present invention; and

FIG. 2 is a flow chart showing a method for detecting an eavesdropping device by using the eavesdropping device detecting system shown in FIG. 1.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

An eavesdropping device detecting system according to the present invention judges an existence of an eavesdropping device 10 based on waves generated from the eavesdropping device 10 and displays a detecting result in an LCD monitor provided in the eavesdropping device detecting system. Thus, the eavesdropping device detecting system can reliably notify the user of the existence of the eavesdropping device 10.

When the eavesdropping device 10 exists, a position of the eavesdropping device 10 is displayed in the LCD monitor as necessary. That is, it is possible to detect an installing position of the eavesdropping device 10.

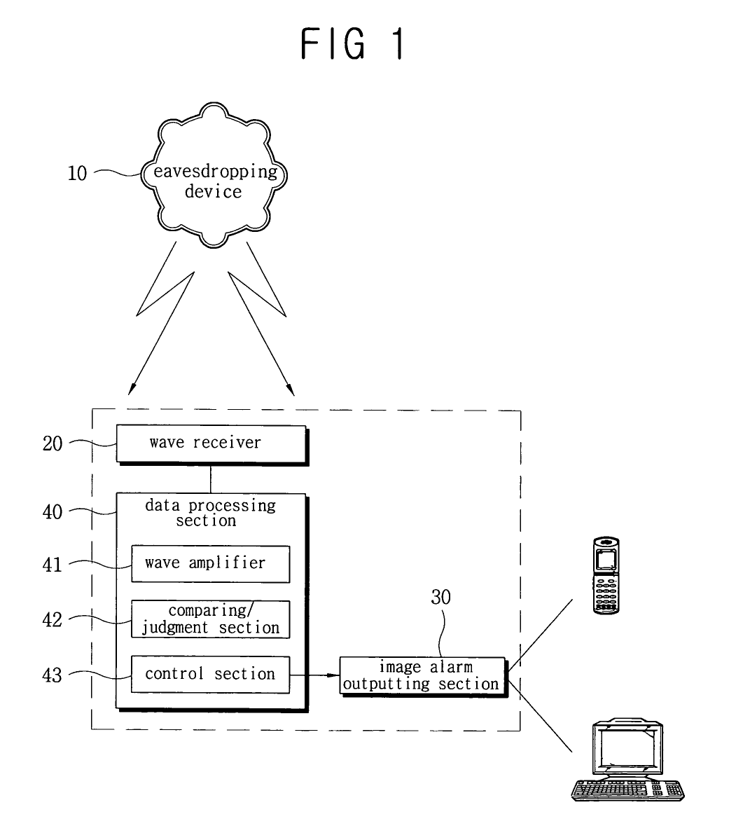

As shown in FIG. 1, such eavesdropping device detecting system includes a wave receiver 20, an image alarm outputting section 30, and a data processing section 40, which judges the existence of the eavesdropping device 10 based on the wave received in the wave receiver 20 and output data thereof to the image alarm outputting section 30.

The wave receiver 20 signifies an AM radio receiver capable of receiving both medium waves of a domestic broadcasting service and short waves of a foreign broadcasting service. Recently, it is not extraordinary for a receiver to be capable of receiving the short waves, so it is usual now to tell receivers from each other by means of frequency bands, such as 2-band and 11-band, which can be received by the receivers, instead of naming a receiver “the waver receiver 20.”

In addition, there are many receivers capable of receiving FM signals as well as AM signals. A T.V. receiver capable receiving both VHF signals and UHF signals is called “all channel receiver” in order to discriminate it from other TV receivers. The wave receiver 20 according to the present invention includes the above-described receivers.

The wave receiver 20 may be installed in conference rooms, facilities or private spaces. In addition, a user can carry the wave receiver 20 so as to continuously receive waves. Of course, the wave receiver 20 may receive not only waves generated from the eavesdropping device 10, but also waves generated from household electronic devices or communication devices. At this time, waves received in the wave receiver 20 are processed by the data processing section 40.

The eavesdropping device 10 according to the present invention includes at least one selected from the group consisting of a voice recorder, a wiretapping device and a hidden camera. Although the voice recorder does not generate the waves, it is included in the eavesdropping device 10 in a broad sense.

The data processing section 40 includes a wave amplifier 41 for amplifying waves received in the wave receiver 20 such that the waves have frequency bands to be processed by the data processing section 40, a comparing/judgment section 42 for comparing the amplified waves with a reference wave of the eavesdropping device 10 and judging whether or not the amplified waves are identical to the waves generated from the eavesdropping device 10, and a control section 43 for operating the image alarm outputting section 30 when the amplified waves match with the waves generated from the eavesdropping device 10.

At this time, at least one of a message and a visual image is outputted through the image alarm outputting section 30 by means of the control section 43 depending on the existence of the eavesdropping device 10. If the eavesdropping device 10 does not exist around the user, no image is displayed.

The image alarm outputting section 30 preferably includes a LCD section provided in the eavesdropping device detecting system of the present invention. The image alarm outputting section 30 is connected to the control section 30 through a wire or a cable. Accordingly, signals transmitted to the image alarm outputting section 30 from the control section 43 can be directly displayed in the LCD section.

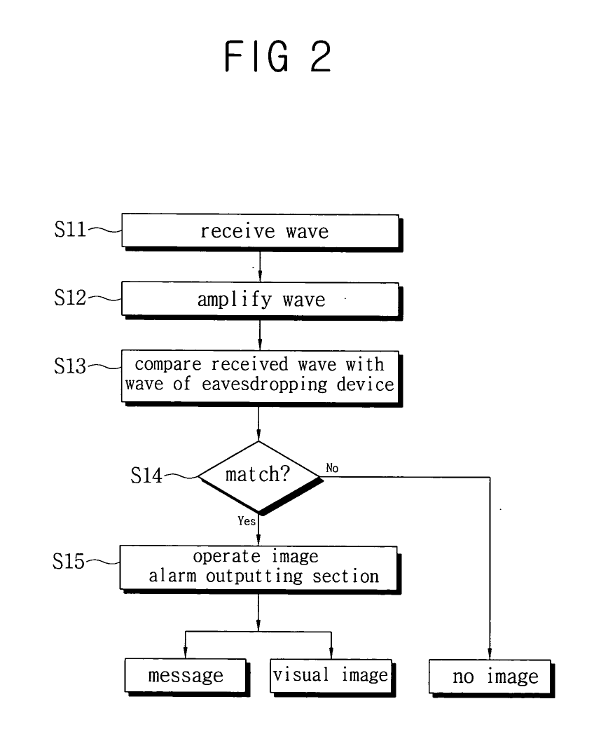

Hereinafter, a detecting method of the eavesdropping device detecting system of the present invention will be described with reference to FIG. 2.

Firstly, the user installs the wave receiver 20 in a required place or carries the wave receiver 20 so as to receive electric waves S11. In a case in which the user receives the waves while carrying the wave receiver 20, it is sufficient even if only one wave receiver 20 is provided. However, if the user wants to install the wave receive 20 in various places, at least two wave receivers 20 will be required.

When the wave receiver 20 receives a predetermined wave, the data processing section 40 judges whether or not the predetermined wave is identical to the wave generated from the eavesdropping device 10. That is, the data processing section 40 amplifies the predetermined wave such that the predetermined wave has a frequency band to be processed by the data processing section 40 (S12), and judges whether or not the amplified wave is equal to the wave generated from the eavesdropping device 10 (S13).

If the amplified wave is equal to the wave generated from the eavesdropping device (S14), the image alarm outputting section 30 is operated (S15). To this end, an intrinsic wave/frequency of the eavesdropping device 10 is stored in the data processing section 40.

If the eavesdropping device 10 is one available from a market, a corresponding intrinsic wave/frequency of the eavesdropping device 10 is inputted into the data processing section 40. However, if the eavesdropping device 10 is a newly developed eavesdropping device, it is necessary to find an intrinsic wave/frequency of the eavesdropping device so as to store the intrinsic wave/frequency of the eavesdropping device in the data processing section 40.

That is, the data processing section 40 of the present invention can easily adjust or reset the intrinsic wave/frequency of the eavesdropping device stored therein. In other words, the data processing section 40 of the present invention has a dedicated program allowing the user to search and select the intrinsic wave/frequency of the eavesdropping device from various intrinsic wave/frequency items.

Accordingly, the control section 43 finally checks the existence of the eavesdropping device 10 based on the judgment of the comparing/judgment section 42 and outputs the result through the image alarm outputting section 30. Thus, information in relation to the existence of the eavesdropping device 10 is displayed as a message or a visual image through the LCD section provided in the eavesdropping device detecting system.

Therefore, the user can reliably recognize the existence of the eavesdropping device 10 through checking the LCD section, so the user can carry out further steps for eliminating the eavesdropping device 10.

If it is determined that the amplified wave is not equal to the wave of the eavesdropping device 10 in step S14, the LCD section displays no image.

As described above, according to the present invention, the user can easily and conveniently recognize the existence of the eavesdropping device 10 at any time by checking the LCD section. Accordingly, it is possible to continuously maintain private security. In addition, since the user can find the position of the eavesdropping device 10, the user can easily carry out further steps for eliminating the eavesdropping device 10.

The eavesdropping device detecting system of the present invention can be fabricated in a compact size at a low cost, so individuals and small-medium enterprises may easily use the eavesdropping device detecting system without a heavy burden.

As mentioned above, the eavesdropping device detecting system and the detecting method thereof according to the present invention can detect the eavesdropping device based on waves generated from the eavesdropping device and display a detecting result as a visual image, so the existence of the eavesdropping device as well as the position of the eavesdropping device can be precisely notified to the user.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An eavesdropping device detecting system comprising: a wave receiver for receiving predetermined waves;
an image alarm outputting section for outputting an existence of an eavesdropping device as at least one of a message and an visual image; and
a data processing section for comparing waves received in the wave receiver with waves of the eavesdropping device to judge the existence of the eavesdropping device and outputting a result thereof to the image alarm outputting section, wherein the data processing section includes a wave amplifier for amplifying waves received in the wave receiver such that the received waves have frequency bands to be processed by the data processing section, a comparing/ judgment section for comparing the amplified waves with the waves of the eavesdropping device and judging whether or not the amplified waves are identical to the waves generated from the eavesdropping device, and a control section for operating the image alarm outputting section when the amplified waves match with the waves generated from the eavesdropping device:

2. The eavesdropping device detecting system as claimed in claim 1, wherein the eavesdropping device is one selected from the group consisting of a voice recorder, a wiretapping device and a hidden camera.

3. The eavesdropping device detecting system as claimed in claim 1, wherein the data processing section is capable of storing a corresponding intrinsic wave/frequency value of the
eavesdropping device therein or the corresponding intrinsic wave/frequency value of the eavesdropping device is stored in the data processing section.

4. The eavesdropping device detecting system as claimed in claim 1, wherein the image alarm outputting section outputs the existence of the eavesdropping device through an LCD section provided in the image alarm outputting section.

5. A method for detecting an eavesdropping device in an eavesdropping device detecting system, the method comprising the steps of:
i) receiving predetermined waves;
ii) comparing received waves with waves of the eavesdropping device and judging an existence of the eavesdropping device; and
iii) displaying the existence of the eavesdropping device as at least one of a message and a visual image, wherein step ii) includes the substeps of:
a) amplifying the received waves such that the received waves have frequency bands to be processed,
b) comparing the amplified waves with the waves of the eavesdropping device and judging whether or not the amplified waves are identical to the waves generated from the eavesdropping device, and
c) operating an image alarm outputting section when the amplified waves match with the waves generated from the eavesdropping device.
